(19) United States
(12) Patent Application Publication
(10) Pub. No.: US 2023/0188898 A1
(43) Pub. Date: Jun. 15, 2023

(54) LOUDSPEAKER

(71) Applicant: Harman Becker Automotive Systems GmbH, Karlsbad (DE)

(72) Inventors: Andreas Helmut Pfeffer, Wenzenbach (DE); Hans-Juergen Regl, Bogen (DE)

(73) Assignee: Harman Becker Automotive Systems GmbH, Karlsbad (DE)

(21) Appl. No.: 18/074,053

(22) Filed: Dec. 2, 2022

(30) Foreign Application Priority Data
Dec. 9, 2021 (EP) 21213437.3

(51) Int. Cl. H04R 9/06; H04R 9/02; H04R 7/18

(52) U.S. Cl. CPC H04R 9/06; H04R 9/025; H04R 7/18; H04R 2400/11

(57) ABSTRACT

A loudspeaker comprises a diaphragm, a tubular voice coil assembly coupled to the diaphragm, a magnet assembly providing an annular gap in which the tubular voice coil assembly is arranged, and a flexible suspension. A longitudinal axis of the tubular voice coil assembly extends along a central axis of the loudspeaker. A longitudinal axis of the annular gap extends along the central axis of the loudspeaker. The flexible suspension has a disc shape and is configured to guide a movement of the tubular voice coil assembly along the central axis of the loudspeaker. The flexible suspension extends substantially perpendicular to the central axis. An inner diameter of the tubular voice coil assembly is greater than or equal to an outer diameter of the flexible suspension.

### CROSS REFERENCE

Priority is claimed to application serial no. 21213437.3, filed Dec. 9, 2021 in Europe, the disclosure of which is incorporated in its entirety by reference.

### TECHNICAL FIELD

The present application relates to the field of loudspeakers, in particular to the field of flat full-spectrum loudspeakers.

### BACKGROUND ART

Loudspeakers are widely used in various areas, for example in consumer products like radios, television sets, audio players, computers, mobile phones and electronic musical instruments, and commercial applications, for example sound reinforcement in theatres, concert halls, and public address systems. Furthermore, in vehicles, for example planes, ships and cars, loudspeakers are widely used.

A loudspeaker may comprise a magnet, in particular a permanent magnet, a voice coil arranged in a magnetic field provided by the magnet, a diaphragm (also called membrane) coupled to the voice coil and elastically coupled via a suspension (also called surround) to a frame of the loudspeaker. For example, the voice coil may be a coil of wire capable of moving axially in a cylindrical gap containing a concentrated magnetic field produced by the permanent magnet. A further flexible suspension, commonly called a “spider”, is provided that constrains the voice coil to move axially through the cylindrical magnetic gap. When an alternating electrical current of for example an electrical audio signal is applied to the voice coil, the voice coil is forced to move back and forth due to the Faraday's law of induction, which causes the membrane attached to the voice coil to move back and forth, pushing on the air to create sound waves. The combination of magnet and voice coil is also called drive unit or electromagnetic motor system. Arrangement and properties of the magnet and voice coil may affect characteristics of a loudspeaker. Characteristics of a loudspeaker may relate to efficiency, i.e. the sound power output divided by the electrical power input, sensitivity, i.e. the sound pressure level at for example 1W electrical input measured at 1 meter, linearity or frequency response, maximum acoustic output power, size and weight. Characteristics may be different for different frequencies, for example small loudspeakers may have lower efficiency at low frequencies than large loudspeakers.

In particular in cars, a plurality of loudspeakers may be arranged at different locations to provide adequate sound output for each occupant. For example, loudspeakers may be arranged in the dashboard, doors, the ceiling, seats and headrests. A full-spectrum audio output may require large installation space; in particular the output of low bass frequencies may require large loudspeakers and large volumes. However, the installation space may be limited, in particular, the available installation depth may be small for loudspeakers for wall mounting or for loudspeakers for installation in vehicles, e.g. in doors, on the ceiling and in the dashboard.

### SUMMARY OF THE INVENTION

In view of the above, there is a need in the art to improve at least some of the above characteristics of a loudspeaker. For example, there is a need for compact sized flat loudspeakers providing high efficiency, in particular at low frequencies.

According to the present invention, a loudspeaker as defined in the independent claim is provided. The dependent claims define embodiments of the invention.

The present disclosure provides a loudspeaker comprising a diaphragm, a tubular voice coil assembly, a magnet assembly and a flexible suspension. The tubular voice coil assembly is coupled to the diaphragm. A longitudinal axis of the tubular voice coil assembly extends along a central axis of the loudspeaker. The magnet assembly provides an annular gap in which the voice coil assembly is arranged. A magnetic field produced by the magnet assembly may be present in the annular gap. For example, lines of magnetic flux may be radially directed in the annular gap. In the art, the annular gap of the magnet assembly is also called air gap or cylindrical magnetic gap. A longitudinal axis of the annular gap extends along the central axis of the loudspeaker. The flexible suspension, which is commonly called “Spider”, has a disc shape and is configured to guide a movement of the voice coil assembly along the central axis of the loudspeaker. The flexible suspension extends substantially perpendicular to the central axis. The flexible suspension may be aligned coaxially with the voice coil. An inner diameter of the voice coil assembly is greater than or equal to an outer diameter of the flexible suspension. In other words, the flexible suspension may extend in an area between the central axis and an inner diameter of the voice coil only. For example, the voice coil assembly may surround the flexible suspension, i.e. the flexible suspension is arranged within the voice coil assembly.

In low-profile designs, for example loudspeaker designs with a height along the central axis of less than 10 or 20 mm, providing a flexible suspension (spider) outside the voice coil assembly may not be possible due to spatial restrictions. However, omitting the flexible suspension may limit the performance in low-frequency range, because of less control on the voice coil at high excursion. Without the flexible suspension, excursion control is performed by the surround only, but the surround is usually not effective at the center of the diaphragm. By arranging the flexible suspension within the voice coil assembly, a flat low-profile design may be achieved while at the same time providing guidance and excursion control at or near the center of the diaphragm. As a result, high-performance may be achieved over a wide spectrum, including in particular at low frequencies.

For example, the voice coil assembly may comprise a tubular carrier and a coil of wire arranged on an outside of the carrier. An inner diameter of the carrier is greater than or equal to the outer diameter of the flexible suspension.

In various examples, the flexible suspension has a corrugated disk shape. In other words, the flexible suspension has the disc shape with concentric grooves and ridges. The flexible suspension may be made of a corrugated fabric disc which is impregnated with a stiffening resin. However, the flexible suspension may be made of other materials, for example plastics or rubber. The flexible suspension may have a disc shape with a central opening, i.e. the flexible suspension may have a shape of a washer. In other examples, the flexible suspension may have a shape of a disc without any opening. Due to the corrugated form in the radial direction of the flexible suspension, the flexible suspension may provide high flexibility in the direction of the central axis and may minimize instabilities and movements during excursion in the radial direction perpendicular to the central axis. I.e., the flexible suspension provides guidance in the direction of the central axis, for example for the voice coil or the diaphragm of the loudspeaker, and can avoid movements that are not in the direction of the central axis.

In some examples, the magnet assembly comprises a magnet and a magnetic piece. The magnet may be made of a magnetic material, i.e. the magnet may be a permanent magnet. The magnetic material of the magnetic piece may comprise any ferromagnetic material, for example iron, a cobalt, nickel or a combination thereof.

For example, the magnet comprises a ring magnet with an axial magnetization, i.e. the magnet may have a right hollow cylindrical shape with a ring shaped cross section. However, the magnet may have any other shape which may be rotationally symmetrical or non-rotationally symmetrical, for example an ellipsoid shape, a polygon shape, a curved shape, or a combination of straight and curved sections. A shape of an inner surface of the magnet may have the same shape as an outer surface of the magnet or the inner surface of the magnet and the outer surface and of the magnet may have different shapes, for example, the inner surface may have a circular shape and the outer surface may have a polygonal shape. In any case, the magnetization may be in the height direction, for example along an axis of rotational symmetry. In combination with the magnetic piece, within the gap a magnetic field (e.g. B-field) may extend in a radial direction.

For example, the magnet may have a right hollow cylindrical shape and the magnetic piece may have also right hollow cylindrical shape. The magnet may have a ring shaped cross section. The magnetic piece may also have a ring shaped cross section. The magnetic piece may be smaller than the magnet such that it can be inserted into the hollow space of the magnet. In particular, an inner diameter of the magnet is larger than an outer diameter of the voice coil assembly. The magnetic piece is at least partially arranged within the voice coil assembly. An outer edge of the flexible suspension is attached to the magnetic piece. For example, the magnet may be a ring magnet arranged outside the voice coil assembly. The ring magnet may be magnetically coupled to the magnetic piece which is arranged within the voice coil assembly. Thus, the annular gap is created between the ring magnet and the magnetic piece. The magnetic piece may limit the inner edge of the annular gap and the ring magnet may limit the outer edge of the annular gap. The gap between the magnet and the magnetic piece may have a right hollow cylindrical shape. In some examples, the gap may have a ring shaped cross section. The magnet, the magnetic piece and thus the gap may have any other appropriate shape, for example a right hollow cylindrical shape with a cross section having an inner and/or outer circumference in the shape of a polygon, an ellipse or a combination of straight and/or curved sections.

A width of the gap may relate to the distance between the magnet and the magnetic piece. The air gap may have a width of a few millimeters, for example in a range of 1 to 5 millimeters. The height of the gap may be in a range of a few millimeters to a few centimeters, for example in a range of 10 to 50 millimeters.

The voice coil assembly is arranged within the ring magnet. Within the voice coil assembly, the magnetic piece is arranged. The flexible suspension extends from the magnetic piece in an inwards radial direction. A central area of the flexible suspension may be attached at least partially to a central area of the diaphragm or a dust cap arranged at a central area of the diaphragm. The flexible suspension thus provides guidance to a central area of the diaphragm, i.e. the flexible suspension constrains the central area of the diaphragm to move axially along the central axis of the loudspeaker.

According to various examples, the loudspeaker further comprises a support structure arranged within the voice coil assembly. An outer edge of the flexible suspension is attached to an inner circumference of the voice coil assembly and a central area of the flexible suspension is at least partially attached to the support structure. The support structure may be a core cap of the loudspeaker or a support coupled to the magnet assembly, for example to a pole piece or magnet of the magnet assembly arranged within the voice coil assembly. The support structure may be a part of a core cap of the loudspeaker, i.e. the support structure may be integrally formed with the core cap of the loudspeaker. Furthermore, the support structure may comprise an additional magnet, e.g. a ring or disk shaped magnet, arranged at the magnet assembly such that opposite polarities of the additional magnet and the magnet assembly are opposing. As a result, the flexible suspension may constrain the voice coil assembly and the diaphragm coupled to the voice coil assembly to move axially along the central axis of the loudspeaker.

According to some other examples, the loudspeaker further comprises a tubular carrier attached to the diaphragm and arranged coaxially to the voice coil assembly. The tubular carrier may be attached to the diaphragm at a central area of the diaphragm. An outer diameter of the tubular carrier is smaller than an inner diameter of the voice coil assembly. The flexible suspension may have a central hole or opening. An edge of the central hole is attached to an outer circumference of the tubular carrier. The flexible suspension may provide guidance for the diaphragm via the tubular carrier. In particular, the flexible suspension may constrain a central area of the diaphragm to move axially along the central axis of the loudspeaker. Furthermore, the tubular carrier may support homogeneous transmission of force from the flexible suspension to the diaphragm.

In various examples, the magnet assembly comprises a magnet and a magnetic piece. An outer diameter of the magnet is smaller than an inner diameter of the voice coil assembly, i.e. the magnet may be arranged within the voice coil assembly. The magnet may be a ring magnet or a disc magnet. The magnetic piece is at least partially arranged outside the voice coil assembly. An outer edge of the flexible suspension is attached to the magnet or a core cap coupled to the magnet. A central area of the flexible suspension may be attached to a central area of the diaphragm, for example directly or indirectly via a tubular carrier as described above. By arranging the magnet within the voice coil assembly, not only a low-profile design, but also a design with compact diameter may be achieved.

According to further examples, the loudspeaker may comprise more than one diaphragm. Therefore, in the following, the above mentioned voice coil assembly will be named first voice coil assembly and the above mentioned diaphragm will be named first diaphragm. The loudspeaker comprises a second diaphragm arranged coaxially to the first diaphragm, and a second voice coil assembly coupled to the second diaphragm. The first diaphragm has a central hole. A diameter of the central hole is larger than or equal to an outer diameter of the second diaphragm. The second diaphragm may be arranged within the central hole of the first diaphragm. The flexible suspension has a central hole also, and an edge of the central hole of the flexible suspension is attached to the first diaphragm. For example, the edge of the central hole of the flexible suspension may essentially be arranged at an edge of them the central hole of the first diaphragm such that a central area of the first diaphragm is guided by the flexible suspension. The second diaphragm may be driven independent from the first diaphragm by the second voice coil assembly. For example, the first diaphragm may be controlled tool generate audio signals in a low and mid-range, for example in the range below 200 Hz whereas the second diaphragm may be controlled tool generate audio signals in a high range above the low and mid-range.

Furthermore, the magnet assembly may comprise a first part arranged outside the first voice coil assembly, a second part arranged between the first voice coil assembly and the second voice coil assembly, and a third part arranged inside the second voice coil assembly. A magnetic field generated by at least one magnet of the magnet assembly may be guided through the first part, second part and third part. In other words, the magnet assembly provides a common magnetic flux which may be used for driving the first voice coil as well as the second voice coil. The common magnetic flux may be generated by a single magnet. Required installation space and weight may be reduced.

A surround may be provided which couples an outer circumference of the second diaphragm to the first diaphragm. For example, the surround may be provided between the edge of the central hole of the first diaphragm and the outer circumference of the second diaphragm to provide support at the outer circumference of the second diaphragm while enabling the first and second diaphragms to oscillate independently.

According to further examples, the magnet assembly comprises a split gap core coupled to a magnet of the magnet assembly. The split gap core provides in an axial direction of the gap a varying magnetic field with two maxima. For example, the split gap core may be configured such that in the direction of the central axis of the loudspeaker two annular gaps are provided. In each of the two annular gaps the magnetic flux is directed in a radial direction. In a first annular gap of the two annular gaps the magnetic flux may be directed outward, and in a second annular gap of the two annular gaps the magnetic flux may be directed inward. The magnetic flux in each of the two annular gaps may be provided by a common magnet of the magnet assembly. The voice coil assembly extends through each of the two annular gaps. The voice coil assembly comprises a first coil of wire with a first direction of winding and a second coil of wire with a second direction of winding opposite to the first direction of winding. In non-deflected state of the loudspeaker, the first coil of wire may be arranged at least partially in the first annular gap, and the second coil of wire may be arranged at least partially in the second annular gap. A common driving current may be conducted through the first and second coils of wire. Upon excursion of the voice coil in the axial direction, there may always be at least one of the first and second coils of wire within the associated first and second annular gaps, respectively. Such arrangement has a large symmetry, which may increase linearity. For example, drive force and inductance may have a value that is more independent of drive current and displacement.

In various examples, the loudspeaker may comprise a basket or frame coupled to the magnet assembly, and a surround coupling an outer circumference of the diaphragm to the basket. The basket may be made of plastics or metal, e.g. aluminum, and may provide supports for mounting the loudspeaker at the place of installation, for example in a door or ceiling of a car or in a housing of a wall mounted speaker system. The surround may be made of elastic materials, for example rubber or plastics

It is to be understood that the features mentioned above and those described in detail below may be used not only in the described combinations, but also in other combinations or in isolation without departing from the scope of the invention.

### BRIEF DESCRIPTION OF THE DRAWINGS

FIG. 1 schematically illustrates a sectional view of a loudspeaker according to various examples comprising a disc shaped flexible suspension;

FIG. 2 schematically illustrates a sectional view of a loudspeaker according to various examples comprising a washer shaped flexible suspension and a tubular carrier;

FIG. 3 schematically illustrates a sectional view of a loudspeaker according to various examples comprising a washer shaped flexible suspension;

FIG. 4 schematically illustrates a sectional view of a loudspeaker according to various examples comprising a washer shaped flexible suspension mounted at a support structure;

FIG. 5 schematically illustrates a sectional view of a loudspeaker according to various examples with a split gap core structure and comprising a washer shaped flexible suspension mounted at a support structure;

FIG. 6 schematically illustrates a sectional view of a loudspeaker according to various examples comprising a washer shaped flexible suspension coupled to a first diaphragm, and a second diaphragm separate from the first diaphragm;

FIG. 7 schematically illustrates a sectional view of a loudspeaker according to various examples comprising a washer shaped flexible suspension coupled to a first diaphragm, a second diaphragm separate from the first diaphragm, and a magnetic circle with two magnets;

FIG. 8 schematically illustrates a sectional view of a loudspeaker according to various examples comprising a washer shaped flexible suspension coupled to a diaphragm driven by two voice coils;

FIG. 9 schematically illustrates a sectional view of a loudspeaker according to various examples comprising a washer shaped flexible suspension coupled to a diaphragm driven by two voice coils, and a magnetic circle with two magnets; and

FIG. 10 schematically illustrates a sectional view of a loudspeaker according to various examples comprising a washer shaped flexible suspension coupled to a diaphragm driven by two voice coils, and a single magnet providing two magnetic circles.

### DETAILED DESCRIPTION OF EMBODIMENTS

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, components, or other physical or functional units shown in the drawings or described herein may also be implemented by an indirect connection or coupling.

Some examples of the present disclosure generally provide for a plurality of mechanical and electrical components. All references to the components and the functionality provided by each are not intended to be limited to encompassing only what is illustrated and described herein. While particular labels may be assigned to the various components disclosed, such labels are not intended to limit the scope of operation for the components. Such components may be combined with each other and/or separated in any manner based on the particular type of implementation that is desired. Same reference signs in the various drawings may refer to similar or identical components.

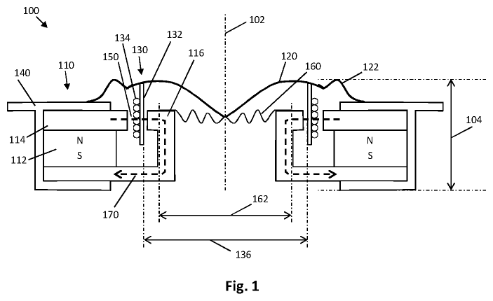

FIG. 1 shows a sectional view a loudspeaker 100. The sectional view is taken along a central axis 102 of the loudspeaker 100. Several of the below described components may have an axis of rotational symmetry, for example circular or tubular components, and the axis of rotational symmetry of such components may be aligned to the central axis 102.

The loudspeaker 100 comprises a magnet assembly 110, a diaphragm 120, a tubular voice coil assembly 130, and a flexible suspension 160. The loudspeaker 100 may furthermore comprise a chassis or basket 140 which supports the magnet assembly 110 and the diaphragm 120. The magnet assembly 110 may be glued to the basket 140 or supported by the basket 140 by press fitting. The basket 140 may be made of a rigid material, for example plastics or aluminum.

The diaphragm 120 is coupled to the basket 140 via a surround 122 which provides a flexible support of the diaphragm 120 with respect to the basket 140 such that the diaphragm 120 is movable in at least the direction of the central axis 102. The surround 122 may enable a movement of the diaphragm back and forth in the direction of the central axis 102 and may restore the diaphragm 120 into a rest position after excursion. The surround 122 may be made of elastic material, for example rubber or plastics. An outer circumference of the diaphragm 120 may be circular such that an axis of rotational symmetry of the diaphragm 120 may be aligned to the central axis 102. However, the outer circumference of the diaphragm 120 may have any other shape, for example an oval or elliptical shape or a polygonal shape. Nevertheless, a center of the diaphragm 120 may be aligned to the central axis 102 of the loudspeaker 100. The diaphragm 120 may be made of paper, plastic, metal or a combination thereof. Other materials may be used. In particular, the material may be rigid to prevent uncontrolled motions, and may have a low mass to minimize starting force issues and may be well damped to reduce vibrations continuing after being deflected and to avoid resonance.

In the example shown in FIG. 1, the diaphragm 120 has a cone shape with an apex directing downwards, i.e. into an opening of the annular magnet assembly 110. The diaphragm 120 may have any other shape, for example a dome shape or a spherical shape.

The magnet assembly 110 provides an annular gap 150 in which the voice coil assembly 130 is arranged without contacting the magnet assembly 110. A longitudinal axis of the annular gap 150 extends along the central axis 102 of the loudspeaker 100. For example, the magnet assembly 110 comprises a permanent magnet 112, a first magnetic piece 114 and a second magnetic piece 116. The magnet 112 may comprise ferromagnetic material, for example iron, nickel, cobalt and/or neodymium. The magnet 112 may be a ring magnet having an axis of rotational symmetry aligned to the central axis 102. The magnet 112 may have, at one end in the direction of the central axis 102, a first magnetic pole, for example a north pole N, and at another end opposing to the one end in the direction of the central axis 102 a second magnetic pole, for example a south pole S. The first and second magnetic pieces 114, 116 may be made of ferromagnetic material, for example iron, nickel or cobalt. As shown in FIG. 1, the first magnetic piece 114 may have a ring or washer shape and the second magnetic piece 116 may have a ring shape with an L-shaped or J-shaped cross-section such that the annular gap 150 is formed between an edge of the first magnetic piece 114 and an edge of the second magnetic piece 116. A magnetic flux 170 from the magnet 112 may be concentrated in the annular gap 150.

The tubular voice coil assembly 130 is arranged such that an axis of rotational symmetry of the voice coil assembly 130 is aligned to the central axis 102. The voice coil assembly 130 extends at least partially within the annular gap 150. The tubular voice coil assembly 130 is coupled to the diaphragm 120, for example by gluing. In the example shown in FIG. 1, the voice coil assembly 130 is coupled to the diaphragm 120 in an outer area of the diaphragm 120. However, in other examples, the voice coil assembly 130 may be coupled to the diaphragm 120 in a more inner area of the diaphragm 120.

The voice coil assembly 130 may comprise a tubular carrier 132 and a coil of wire 134 arranged on an outside of the carrier 132. The carrier 132 may be made of a non-magnetic material, for example paper, aluminum or plastics, like polyimide, for example Kapton. Upon energizing the coil of wire 134 with electrical energy, the coil of wire 134 generates a magnetic field which interacts with the magnetic field within the annular gap 150 such that the voice coil assembly 130 is urged in the direction of the central axis 102. Depending on a direction and amplitude of an electrical current supplied to the coil of wire 134, the amount and direction of movement of the voice coil assembly 130 may be controlled. However, care has to be taken that the voice coil assembly 130 is essentially moved only in the direction of the central axis 102 to avoid contact between the voice coil assembly 130 and the magnetic pieces 114 and 116 and to achieve linearity. For utilizing this, the flexible suspension 160 is provided.

The flexible suspension 160, commonly called “spider”, has a corrugated disc shape. I.e., the flexible suspension 160 may have a waveform in the radial direction. The flexible suspension 160 may be made of a fabric. For example, the flexible suspension 160 may comprise a fiber reinforced material comprising for example cotton, silk, aramid fibers, plastics, carbon fibers, glass fibers, resin or rubber. In the example shown in FIG. 1, a central area of the flexible suspension 160 is coupled to the apex or a central area of the diaphragm 120. An outer circumference of the flexible suspension 160 is coupled to the second magnetic piece 116, for example at an inner circumference of the second magnetic piece 116. The flexible suspension 160 may be glued to the second magnetic piece 116.

Due to the corrugated structure of the flexible suspension 160, the flexible suspension 160 constrains at least the central area of the diaphragm 120 to move substantially in the direction of the central axis 102. The rigidity of the diaphragm 120 traverses the guidance from the flexible suspension 160 to the voice coil assembly 130 such that the flexible suspension 160 at least indirectly constrains the voice coil assembly 113 to move along the central axis 102 of the loudspeaker 100. I.e., the flexible suspension 160 allows the voice coil assembly 130 to move substantially only along the central axis 102. In other examples, which will be described below in more detail, the flexible suspension 160 may be directly coupled to the voice coil assembly 130.

It is to be noticed that an inner diameter 136 of the voice coil assembly 130 is greater than an outer diameter and 162 of the flexible suspension 160. In particular, the flexible suspension 160 extends between the central axis 102 and a part of the second magnetic piece 116 which is arranged within the voice coil assembly 130. Arranging the flexible suspension 160 within the voice coil assembly 130 enables a flat design of the loudspeaker 100, i.e. a height 104 of the loudspeaker 100 in the direction of the central axis 102 may become small. For example, a loudspeaker as shown in FIG. 1 may have a height 104 of less than 20 or 50 mm with an outer diameter of the diaphragm 120 in a range of 150 to 300 mm. Height 104 may be much less than 20 mm, e.g. 10 mm.

In general, the flexible suspension 160 may provide guidance in the direction of the central axis 102. For example, the flexible suspension 160 may inhibit or reduce a deflection of the diaphragm 120 in the lateral direction, i.e. in a radial direction perpendicular to the central axis 102. The flexible suspension 160 enables deflection in the direction of the central axis 102 and provides a restoring force to a rest position for the diaphragm 120 and the voice coil assembly 130.

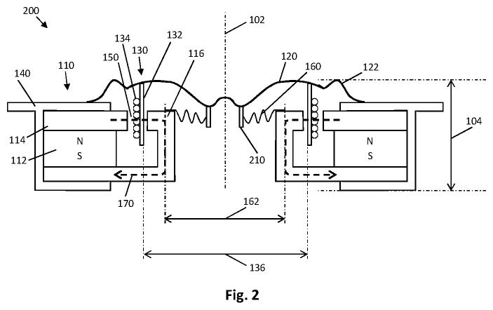

FIG. 2 illustrates a further loudspeaker 200 with a similar structure as the loudspeaker 100 shown in FIG. 1. The basket 140, the magnet assembly 110 and the voice coil 130 have essentially the same structure as the corresponding components of the loudspeaker 100 of FIG. 1. The loudspeaker 200 of FIG. 2 differs from the loudspeaker 100 of FIG. 1 at least in the shape of the diaphragm 120, the flexible suspension 160 and the connection between these components. As illustrated in FIG. 2, in a central area of the diaphragm 120 a tubular carrier 210 is provided which may be aligned to the central axis 102 of the loudspeaker 200. As a result, the tubular carrier 210 is arranged coaxially to the voice coil assembly 130. An outer diameter of the tubular carrier 210 is smaller than the inner diameter of the voice coil assembly 130, i.e. the tubular carrier 210 is arranged within the voice coil assembly 130. The tubular carrier 210 is also arranged within the second magnetic piece 116. A base of the tubular carrier 210 is mounted at the diaphragm 120, for example by gluing. The flexible suspension 160 has a disc shape with a central opening, i.e. the flexible suspension 160 has a washer shape. The outer diameter of the tubular carrier 210 may correspond to the diameter of the central opening of the flexible suspension 160. The edge of the central opening of the flexible suspension 160 may be mounted at the outer circumference of the tubular carrier 210, for example by gluing or press fitting. The tubular carrier may be made of a rigid material, for example plastics or aluminum.

The washer shaped flexible suspension 160 may have a corrugated cross-section in the radial direction. An outer edge of the flexible suspension 160 may be mounted at the second magnetic piece 116. As a result, the flexible suspension 160 constrains the tubular carrier 210 to move essentially only in the direction of the central axis 102, but not in any direction perpendicular to the direction of the central axis 102. Due to the rigidity of the carrier 210, additional stiffness may be provided for the diaphragm 120. Stiffness of the diaphragm 120 may further be increased by the shape of the diaphragm 120 in the radial direction, for example, as shown in FIG. 2, by providing an arched surface in the contact area with the tubular support 210. As the flexible suspension 160 provides guidance of the movement of the diaphragm 120 in essentially the direction of the central axis 102 only, a reliable guidance of the voice coil assembly 130 within the gap 150 is provided such that the voice coil assembly 130 can move essentially in the up and down direction along the central axis 102 only. As explained above in connection with the loudspeaker 100 shown in FIG. 1, a flat loudspeaker design may be achieved by arranging the flexible suspension 160 within the voice coil assembly 130, while at the same time achieving reliable guidance and control of the diaphragm 120 and the voice coil assembly 130.

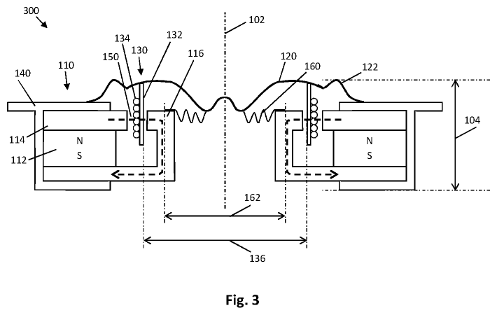

FIG. 3 shows a further loudspeaker 300 which corresponds, at least to a large extent, to the loudspeaker 200 shown in FIG. 2. The loudspeaker 300 of FIG. 3 distinguishes from the loudspeaker 200 of FIG. 2 at least in that the loudspeaker 300 of FIG. 3 does not comprise the tubular support 210. Instead, the inner edge of the flexible suspension 160, i.e. the edge of the central opening of the flexible suspension 160, is directly coupled to a central area of the diaphragm 120. As described in connection with FIG. 2, the flexible suspension 160 may have a corrugated cross-section in the radial direction and an outer edge of the flexible suspension 160 may be mounted at the second magnetic piece 116. Thus, the flexible suspension 160 constrains the diaphragm 120 together with the voice coil assembly 130 to move essentially in the direction of the central axis 102 only.

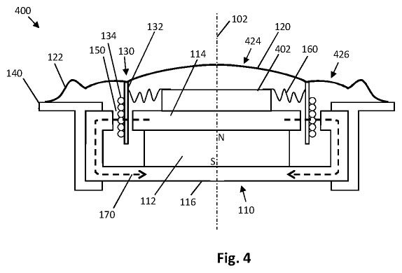

FIG. 4 illustrates a further loudspeaker 400 comprising a magnet assembly 110, a diaphragm 120, a voice coil assembly 130 and a flexible suspension 160. In contrast to the loudspeakers 100, 200, 300 of FIGS. 1 to 3, the magnet 112 of the magnet assembly 110 of the loudspeaker 400 of FIG. 4 is arranged within the voice coil assembly 130. A first magnetic piece 114 and a second magnetic piece 116 guide the magnetic flux 170 from the magnet 112 through a gap 150 in which the voice coil assembly 130 is arranged. The magnet 112, the first magnetic piece 114 and the second magnetic piece 116 may each have an axis of rotational symmetry and may be each aligned to the central axis 102 of the loudspeaker 400. The magnet 112 may be a disc magnet with a first magnetic pole at a first base of the magnet 112 and an opposite second magnetic pole at an opposite second base of the magnet 112. The first magnetic piece 114 is arranged at the first base and the second magnetic piece 116 is arranged at the second base. The first magnetic piece 114 may have a disc shape, and the second magnetic piece 116 may have a shape with rotational symmetry and J- or L-cross-section along a radius.

On a surface of the first magnetic piece 114 opposite to the surface with which the first magnetic piece 114 is in contact with the magnet 112, a support structure 402 is provided. The support structure 402 may be made of non-magnetic material, for example a paramagnetic, diamagnetic, or anti-ferromagnetic material. For example, the support structure 402 may be made of plastics or a non-magnetic metal like aluminum. In other examples, the support structure 402 may be made of ferromagnetic materials. The support structure 402 may have a disc shape. An axis of rotational symmetry of the support structure 402 may be aligned to the central axis 102.

In further examples, the support structure 402 may be a part of the first magnetic piece 114 of the loudspeaker 400, i.e., the support structure 402 may be integrally formed with the first magnetic piece 114. In other examples, the support structure 402 may comprise an additional magnet, for example a ring-shaped or disc-shaped magnet, arranged on the magnet assembly 110 such that the polarities of the additional magnet (i.e. the support structure 402) and the magnet assembly 110 are opposite to each other.

As shown in FIG. 4, the diaphragm 120 may have a spherical shape with one radius in a central area 424 and another radius in a marginal area 426. The voice coil assembly 130 is mounted in the transition area between the central area 424 and the marginal area 426. The flexible suspension 160 has a washer shape with a central opening. An edge of the central opening of the flexible suspension 160 is mounted at the support structure 402, for example by gluing. The washer shaped flexible suspension 160 may have a corrugated cross-section in the radial direction. An outer circumference of the flexible suspension 160 may essentially correspond to an inner circumference of the carrier 132 of the voice coil assembly 130. The flexible suspension 160 is arranged within the voice coil assembly 130, in particular, the outer edge of the flexible suspension 160 is mounted at the inner surface of the carrier 132 of the voice coil assembly 130, for example by gluing. By arranging the flexible suspension 160 within the voice coil assembly 130 and arranging the magnet 112 and the first magnetic piece 114 within the voice coil assembly 130, a compact design of the loudspeaker 400 may be achieved. In particular, a low height and a small diameter may be achieved, wherein the diameter is essentially dictated by the diameter of the diaphragm 120.

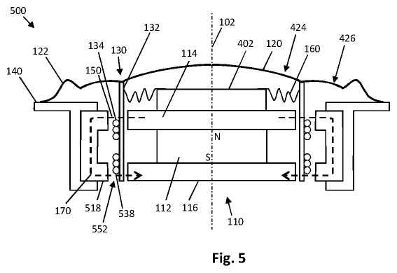

FIG. 5 shows a further loudspeaker 500 with a magnet 112 being arranged within the voice coil assembly 130 as the loudspeaker 400 of FIG. 4. The magnet assembly 110 of the loudspeaker 500 of FIG. 5 provides, besides the first annular gap 150, a second annular gap 552. To accomplish this, the magnet assembly 110 comprises a disc shaped magnet 112, a disc shaped first magnetic piece 114 at one base of the magnet 112, a disc shaped second magnetic piece 116 at the other base of the magnet 112, and a third annular magnetic piece 518 surrounding the stack of the first magnetic piece 114, the magnet 112 and the second magnetic piece 116. As indicated by the dashed arrow in FIG. 5, a magnetic flux 170 from the magnet 112 is guided by the first magnetic piece 114 in an radial outward direction through the first gap 150 into the third magnetic piece 518 and from there through the second gap 552 into the second magnetic piece 116 and back to the magnet 112. The magnetic flux 170 of the magnet 112 is used twice, but must also bridge two air gaps 150, 552. Therefore, in this description, such magnet assembly 110 will be called “split gap core”.

The voice coil assembly 130 comprises a carrier 132 and a first coil of wire 134 and a second coil of wire 538. The first coil of wire 134 has a first direction of winding and the second coil of wire 538 has a second direction of winding which is opposite to the first direction of winding. The carrier 132 extends through the first gap 150 and the second gap 552. A current for driving the voice coil assembly 130 may be conducted through the first and second coils of wire 134 and 538 in series. The voice coil assembly 130 may be configured such that, in a rest position of the loudspeaker 500, the first coil of wire 134 is at least partially arranged within the first annular gap 150, and the second coil of wire 538 is at least partially arranged within the second annular gap 552. The split gap core in combination with this voice coil assembly 130 has a large symmetry and improved linearity, even at large excursion of the diaphragm 120.

As described in connection with the loudspeaker of the FIG. 4, a support structure 402 is provided at the first magnetic piece 114. At the support structure 402, an edge of the central opening of the flexible suspension 160 is mounted. An outer circumference of the flexible suspension 160 is mounted at the inner circumference of the carrier 132 of the voice coil assembly 130. A further (not shown) flexible suspension may be provided at another height of the voice coil assembly 130 for additional guidance and support of the voice coil assembly 130. For example, the further flexible suspension may have a washer shape. An edge of a central opening of the further flexible suspension may be mounted at the outer circumference of the magnet 112, and an outer circumference of the further flexible suspension may be mounted at the inner circumference of the carrier 132 of the voice coil assembly 130.

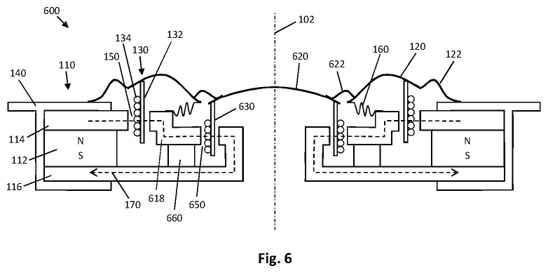

A further exemplary loudspeaker 600 is illustrated in FIG. 6. The loudspeaker 600 comprises a magnet assembly 110, a first diaphragm 120, a second diaphragm 620, and a basket 140. The first diaphragm 120 has an annular shape such that the second diaphragm 620 may be arranged within an opening of the first diaphragm 120. An outer edge of the first diaphragm 120 is coupled via a first surround 122 to the basket 140. An outer edge of the second diaphragm 620 is coupled to an inner edge of the first diaphragm 120 via a second surround 622. A first voice coil assembly 130 is mounted at the first diaphragm 120, and a second voice coil assembly 630 is mounted at the second diaphragm 620. Structures of the first voice coil assembly 130 and the second voice coil assembly 630 may essentially correspond to the structure of the voice coil assembly 130 described above in connection with FIGS. 1 to 5.

The magnet assembly 110 provides a first annular gap 150 and a second annular gap 650. For example, the magnet assembly 110 may comprise a magnet 112, a first magnetic piece 114, a second magnetic piece 116, and a magnetic interim piece 618. A spacer 660 may be provided between the magnetic interim piece 618 and the second magnetic piece 116 for supporting the magnetic interim piece 618. The spacer 660 may be made of non-magnetic material, for example a paramagnetic, diamagnetic, or antiferromagnetic material. For example, the spacer 660 may be made of plastics or a non-magnetic metal like aluminum.

The magnet assembly 110 may be configured such that the magnetic flux 170 from a first pole of the magnet 112, for example the north pole N, is guided subsequently through the first magnetic piece 114, the first annular gap 150, the magnetic interim piece 618, the second annular gap 650 and the second magnetic piece 116 to a second pole of the magnet 112, for example the south pole S. In the first annular gap 150, the first voice coil assembly 130 is arranged. In the second annular gap 650, the second voice coil assembly 630 is arranged. The first voice coil assembly 130 drives the first diaphragm 120 and the second voice coil assembly 630 drives of the second diaphragm 620. The first and second diaphragms 120, 620 may be controlled independently. For example, a first driving signal representing low frequencies, for example below 100 Hz or 200 Hz, may be supplied to the first voice coil assembly 130 for generating low-frequency audio output by the first diaphragm 120. A second driving signal representing high frequencies, for example above 100 Hz or 200 Hz, may be supplied to the second voice coil assembly 630 for generating high frequency audio output by the second diaphragm 620. Thus, audio signals in a wide frequency range may be output by the loudspeaker 600 which requires a single magnet 112 only and has a compact design.

A flexible suspension 160 is provided within the first voice coil assembly 130. The flexible suspension 160 may have a corrugated disc shape with a central opening, i.e. the flexible suspension 160 may have a washer shape. For example, an outer edge of the flexible suspension 160 may be coupled to the magnetic interim piece 618, and an inner edge of the flexible suspension 160 may be coupled to an inner edge of the first diaphragm 120. The flexible suspension 160 guides a movement of the first diaphragm 120 such that it constrains the first voice coil assembly 130 to move essentially in the direction of the central axis 102 only. Furthermore, the flexible suspension 160 also guides the movement of the second diaphragm 620 via the second surround 622 such that it constrains the second voice coil assembly 630 to move essentially in the direction of the central axis 102 only. As a result, a compact and in particular flat design of the loudspeaker 600 may be achieved.

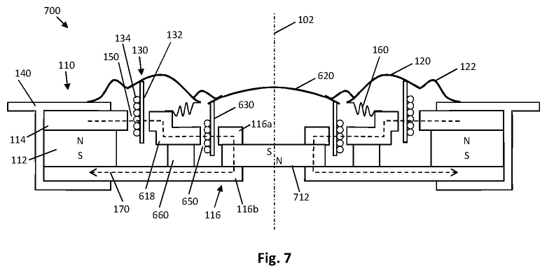

FIG. 7 shows a further loudspeaker 700 with a similar structure as the loudspeaker 600 of FIG. 6. In contrast to the loudspeaker 600 of FIG. 6, the loudspeaker 700 of FIG. 7 comprises, in the magnet assembly 110, a second magnet 712. The second magnet 712 may have a disc or ring shape and is arranged within the second voice coil assembly 630. The second magnet 712 may be part of the second magnetic piece 116. As shown in FIG. 7, the second magnetic piece 116 comprises a first part 116a and a second part 116b. The magnetic flux 170 of the magnets 112 and 712 may be conducted by the magnet assembly 110 as follows: the magnetic flux 170 from a first pole of the first magnet 112, for example a north pole N, is guided by the first magnetic piece 114 through the first gap 150 and further by the magnetic interim piece 618 through the second gap 650. Then, the magnetic flux 170 is guided by the first part 116a of the second magnetic piece 116 to a first pole of the second magnet 712. The first pole of the second magnet has a polarity opposite to the polarity of the first pole of the first magnet 112, for example a south pole S. Furthermore, the magnetic flux 170 is guided by the second part 116b of the second magnetic piece 116 from a second pole of the second magnet, for example a north pole N, to a second pole of the first magnet 112, for example a south pole S. As a result, the first and second magnets 112, 712 cooperate to generate the magnetic flux 170. In some implementations, this may increase the resulting magnetic flux 170 which may contribute to increase the output power of the loudspeaker 700. In other implementations, each of the first and second magnets 112, 712 may be made smaller thus reducing the installation space of the loudspeaker 700 without reducing the output power.

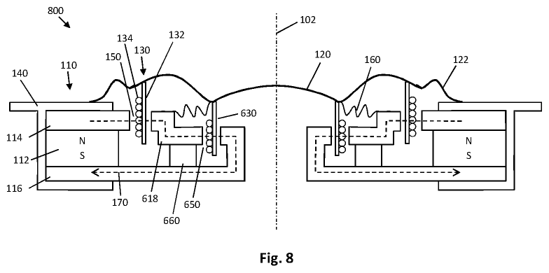

FIG. 8 illustrates a further exemplary loudspeaker 800. The loudspeaker 800 comprises a magnet assembly 110, a diaphragm 120, a first tubular voice coil assembly 130 and a second tubular voice coil assembly 630 and a basket 140. The first voice coil assembly 130 has a larger diameter than the second voice coil assembly 630. The second voice coil assembly 630 is arranged within the first voice coil assembly 130. The first voice coil assembly and the second voice coil assembly are arranged coaxially and aligned to the central axis 102. Both, the first and second voice coil assemblies 130, 630 are mounted at the diaphragm 120. The first voice coil assembly 130 is mounted in an outer area of the diaphragm 120, whereas the second voice coil assembly 630 is mounted to the diaphragm 120 in an area between a center of the diaphragm 120 and the first voice coil assembly 130. The structures of the first voice coil assembly 130 and the second voice coil assembly 630 may essentially correspond to the structure of the voice coil assembly 130 described above in connection with FIGS. 1 to 5.

The magnet assembly 110 provides a first annular gap 150 and a second annular gap 650. As shown, the magnet assembly 110 may comprise a magnet 112, a first magnetic piece 114, a second magnetic piece 116, and a magnetic interim piece 618. The magnet assembly 110 is configured such that a magnetic flux 170 from a first pole of the magnet 112, for example the north pole N, is a guided subsequently through the first magnetic piece 114, the first annular gap 150, the magnetic interim piece 618, the second annular gap 650 and the second magnetic piece 116 to a second pole of the magnet 112, for example a south pole S. The first voice coil assembly 130 is arranged in the first annular gap 150, and the second voice coil assembly 630 is arranged in the second annular gap 650. The first and second voice coil assemblies 130, 630 commonly drive the diaphragm 120. In particular, a diaphragm 120 having a large diameter, for example a diaphragm of a bass loudspeaker with a diameter of 150 mm or more, may be efficiently driven by the two voice coil assemblies 130, 630, increasing for example output power and linearity, while at the same time providing a low-profile and lightweight design.

A flexible suspension 160 is provided within the first voice coil assembly 130. The flexible suspension 160 may have a corrugated disc shape with a central opening, i.e. the flexible suspension 160 may have a washer shape. For example, an outer edge of the flexible suspension 160 may be coupled to the magnetic interim piece 618, and an inner edge of the flexible suspension 160 may be coupled to the diaphragm 120, for example near the mounting of the second voice coil assembly 630. The flexible suspension 160 guides a movement of the diaphragm 120 such that it constrains the first voice coil assembly 130 to move essentially in the direction of the central axis 102 only. Furthermore, the flexible suspension 160 also constrains the second voice coil assembly 630 to move essentially in the direction of the central axis 102 only. As a result, a single flexible suspension 160 controls movement of both first and second voice coil assemblies 130, 630.

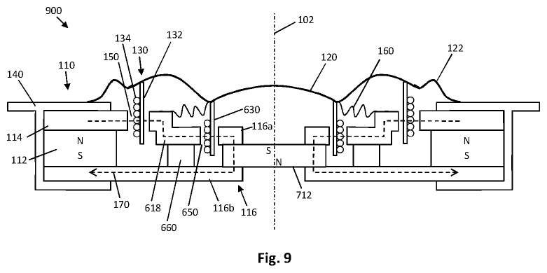

The loudspeaker 900 illustrated in FIG. 9 has a similar structure as the loudspeaker 800 of FIG. 8. In contrast to the loudspeaker 800 of FIG. 8, the loudspeaker 900 of FIG. 9 comprises, in the magnet assembly 110, a second magnet 712. The second magnet 712 may have a disc or ring shape and is arranged within the second voice coil assembly 630. The second magnet 712 may be part of the second magnetic piece 116. As shown in FIG. 9, the second magnetic piece 116 comprises a first part 116a and a second part 116b. The magnetic flux 170 within the magnet assembly 110 may be as follows: the magnetic flux 170 is guided by the first magnetic piece 114 from a first pole (for example a north pole N) of the first magnet 112 through the first gap 150 and further by the magnetic interim piece 618 through the second gap 650. Then, the magnetic flux 170 is guided by the first part 116a of the second magnetic piece 116 to a first pole (for example a south pole S) of the second magnet 712 which is opposite to the first pole of the first magnet 112. Finally, the magnetic flux 170 is guided by the second part 116b of the second magnetic piece 116 from a second pole of the second magnet (for example a north pole N) to a second pole of the first magnet 112 (for example a south pole S). Thus, the first and second magnets 112, 712 cooperate to generate the magnetic flux 170. In some implementations, this may increase the resulting magnetic flux 170 which may contribute to increase the output power of the loudspeaker 900. In other implementations, each of the first and second magnets 112, 712 may be made smaller thus reducing the installation space of the loudspeaker 900 without reducing the output power.

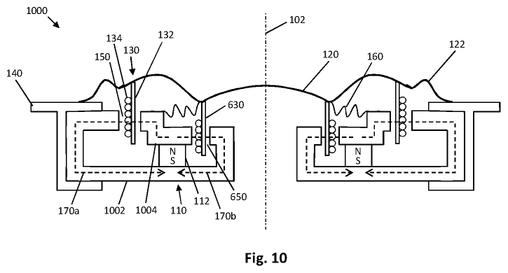

FIG. 10 illustrates a further loudspeaker 1000 which has a similar structure as the loudspeakers 800 and 900 shown in FIGS. 8 and 9. A substantial difference lies in the magnet assembly 110. The magnet assembly 110 comprises an enclosing magnetic piece 1002 extending from inside the second voice coil assembly 630 to an area outside the first voice coil assembly 130. The enclosing magnetic piece 1002 has a U-shaped cross-section in a radial direction. Between the first voice coil assembly 130 and the second voice coil assembly 630, an interim magnetic piece 1004 is provided. A first annular gap 150 is formed between one edge of the enclosing magnetic piece 1002 and one edge of the interim magnetic piece 1004. A second annular gap 650 is formed between another edge of the enclosing magnetic piece 1002 and another edge of the interim magnetic piece 1004. The first voice coil assembly 130 extends in the first annular gap 150 and the second voice coil assembly 630 extends in the second annular gap 650. A magnet 112, for example a ring magnet, is provided between the first voice coil assembly 130 and the second voice coil assembly 630. One base of the magnet 112 is in contact with the enclosing magnetic piece 1002 and another base of the magnet 112 is in contact with the interim magnetic piece 1004. Magnetic flux generated by the magnet 112 is guided by the enclosing magnetic piece 1002 and the interim magnetic piece 1004 as follows: a first part 170a of the magnetic flux is guided from a first pole of the magnet 112 (for example the north pole N) by the interim magnetic piece 1004 through the first annular gap 150 and further by one leg of the enclosing magnetic piece 1002 back to a second pole of the magnet 112 (for example the south pole S). A second part 170b of the magnetic flux is guided from the first pole of the magnet 112 by the interim magnetic piece through the second annular gap 650 and further by the other leg of the enclosing magnetic piece 1002 back to the second pole of the magnet 112. As a result, a single magnet provides magnetic flux for two separate annular gaps 150, 650. The two voice coil assemblies 130 and 630, which commonly drive the diaphragm 120, may increase total output power of the loudspeaker 1000 while achieving a compact and lightweight design. Furthermore, linearity of the loudspeaker 1000 may be improved, in particular in connection with a diaphragm 120 with a large diameter as required for low frequency output.

The above described shapes of the (first) diaphragm 120 and the second diaphragm 620 are examples only and the diaphragms 120, 620 may have any other shape, for example a conical shape, a flat disk shape, a spherical shape, a dome shape, a horn shape, a funnel shape or a combination thereof. Each of the diaphragms 120, 620 may be made from one piece or assembled from several pieces, which are made of the same or different materials.

As described above, some of the components of the loudspeaker may have a rotational symmetry with respect to the central axis 102. Therefore, components on the right-hand side in the FIGs. are shown in symmetry to components on the left-hand side of the FIGs.

What is claimed is:

1. A loudspeaker, comprising:
a diaphragm,
a tubular voice coil assembly coupled to the diaphragm, a longitudinal axis of the tubular voice coil assembly extending along a central axis of the loudspeaker;
a magnet assembly providing an annular gap in which the tubular voice coil assembly is arranged, a longitudinal axis of the annular gap extends along the central axis of the loudspeaker;
a flexible suspension having a disc shape and configured to guide a movement of the tubular voice coil assembly along the central axis of the loudspeaker, the flexible suspension extends substantially perpendicular to the central axis; and
wherein an inner diameter of the tubular voice coil assembly is greater than or equal to an outer diameter of the flexible suspension.

2. The loudspeaker of claim 1, wherein the voice coil assembly surrounds the flexible suspension.

3. The loudspeaker of claim 1, wherein the voice coil assembly further comprises:
a tubular carrier; and
a coil of wire arranged on an outside of the tubular carrier, an inner diameter of the tubular carrier is greater than or equal to the outer diameter of the flexible suspension.

4. The loudspeaker of claim 3, wherein the voice coil assembly surrounds the flexible suspension.

5. The loudspeaker of claim 1, wherein the flexible suspension has a corrugated disk shape.

6. The loudspeaker of claim 1, wherein:
the magnet assembly further comprises:
a ring magnet having an inner diameter that is larger than an outer diameter of the tubular voice coil assembly;
a magnetic piece at least partially arranged within the tubular voice coil assembly; and
an outer edge of the flexible suspension is attached to the magnetic piece.

7. The loudspeaker of claim 6, wherein a central area of the flexible suspension is at least partially attached to the diaphragm.

8. The loudspeaker of claim 1, further comprising:
a support structure arranged within the tubular voice coil assembly;
an outer edge of the flexible suspension is attached to an inner circumference of the tubular voice coil assembly; and
a central area of the flexible suspension is at least partially attached to the support structure.

9. The loudspeaker of claim 8, wherein the support structure is at least one of:
an integral part of a core cap of the magnet assembly
a support coupled to the magnet assembly; and
an additional magnet arranged at the magnet assembly.

10. The loudspeaker of claim 1, further comprising:
a tubular carrier attached to the diaphragm and arranged coaxially to the tubular voice coil assembly;
an outer diameter of the tubular carrier is smaller than an inner diameter of the tubular voice coil assembly;
the flexible suspension has a central opening; and
an edge of the central opening is attached to an outer circumference of the tubular carrier.

11. The loudspeaker of claim 1, wherein:
the magnet assembly further comprises:
a ring magnet; having an outer diameter that is smaller than an inner diameter of the tubular voice coil assembly; and
a magnetic piece at least partially arranged outside the tubular voice coil assembly; and
an outer edge of the flexible suspension is attached to the ring magnet.

12. The loudspeaker of claim 1, wherein:
the magnet assembly further comprises:
a ring magnet; and
a magnetic piece;
an outer diameter of the ring magnet is smaller than an inner diameter of the tubular coil assembly;
the magnetic piece is at least partially arranged outside the tubular voice coil assembly; and
an outer edge of the flexible suspension is attached to a core cap coupled to the ring magnet.

13. The loudspeaker of claim 1, further comprising:
the tubular voice coil assembly has a first tubular voice coil assembly;
a second tubular voice coil assembly is coupled to the first tubular voice coil assembly;
the diaphragm has a first diaphragm;
a second diaphragm is arranged coaxially to the first diaphragm;
a central hole in the first diaphragm, the central hole in the first diaphragm has a diameter larger than or equal to an outer diameter of the second diaphragm; and
the flexible suspension has a central hole, an edge of the central hole of the flexible suspension is attached to the first diaphragm.

14. The loudspeaker of claim 13, further comprising a surround coupling an outer circumference of the second diaphragm to the first diaphragm.

15. The loudspeaker of claim 13, wherein the magnet assembly further comprises:
a first part arranged outside the first tubular voice coil assembly;
a second part arranged between the first tubular voice coil assembly and the second tubular voice coil assembly;
a third part arranged inside the second tubular voice coil assembly; and
a magnetic field generated by at least one magnet of the magnet assembly being guided through the first part, second part and third part.

16. The loudspeaker of claim 15, further comprising a surround coupling an outer circumference of the second diaphragm to the first diaphragm.

17. The loudspeaker of claim 1, wherein:
the magnet assembly further comprises:
a split gap core coupled to a magnet of the magnet assembly, the split gap core providing, in an axial direction of a gap in the split gap core, a varying magnetic field with at least two maxima; and
the tubular voice coil assembly further comprises:
a first coil of wire with a first direction of winding; and
a second coil of wire with a second direction of winding opposite to the first direction of winding.

18. The loudspeaker of claim 1, further comprising:
a basket coupled to the magnet assembly; and
a surround coupling an outer circumference of the diaphragm to the basket.
